(19) United States
(12) Patent Application Publication
(10) Pub. No.: US 2008/0134468 A1
(43) Pub. Date: Jun. 12, 2008

(54) Pivotal device

(75) Inventors: Jason Chen, Shulin City (TW); Chung-Yi Lin, Shulin City (TW)

Correspondence Address: BACON & THOMAS, PLLC, 625 SLATERS LANE, FOURTH FLOOR, ALEXANDRIA, VA, 22314, US

(73) Assignee: SHIN ZU SHING CO., LTD., Shulin City (TW)

(21) Appl. No.: 11/634,096

(22) Filed: Dec. 6, 2006

(51) Int. Cl. E05C 17/64

(52) U.S. Cl. 16/340

(57) ABSTRACT

A pivotal device has a first support, a first axle, a second support and a second axle. The first support has a first seat with an axle hole. The first axle is pivotally mounted on the first support and has a first post and a first holder. The first post is inserted rotatably into the axle hole. The first holder is attached securely to the first seat. The second support is attached securely to the first support and has a second seat with an opening. The second axle is pivotally mounted on the second support and has a second post and a second holder. The second post is inserted rotatably into the opening of the second seat. The second holder is attached securely to a cover of an electrical device. Hence, the electrical device can be folded or unfolded through the pivotal device smoothly.

### BACKGROUND OF THE INVENTION

1. Field of the Invention

The present invention relates to a pivotal device, and more particularly to a pivotal device with two axles.

2. Description of the Related Art

A pivotal device is widely used in electrical devices such as mobile phones and notebooks and therefore, the cover of the electrical devices can be smoothly pivotally moved towards the base.

A conventional pivotal device has a first support connected to the cover of the electrical device, and a second support connected to the base of the electrical device. The first support has a hole defined therein and the second support is pivotally connected to the first support. The second support has an axle extending out thereof to insert into the hole of the first support.

When the first support is folded on the second support, the base can be covered with the cover. However, the cover and the base can be overlapped with each other only when the base and the cover are distorted. Additionally, the electrical device can not be unfolded smoothly or the conventional pivotal device is extended out the cover and the base to influence the aesthetics of the electrical device.

Therefore, the invention provides a pivotal device to mitigate or obviate the aforementioned problems.

### SUMMARY OF THE INVENTION

The main objective of the present invention is to provide a pivotal device that can enable the cover and the base unfolded smoothly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pivotal device in accordance with the present invention;

FIG. 2 is an exploded perspective view of the pivotal device in FIG. 1;

FIG. 3 is a perspective view of the pivotal device in FIG. 1 mounted in an electrical; device;

FIG. 4 is an operational perspective view of the pivotal device in FIG. 1;

FIG. 5 is an operational perspective view of the pivotal device in FIG. 1 mounted in the electrical device;

FIG. 6 is an operational perspective view of the pivotal device in FIG. 1; and

FIG. 7 is an operational perspective view of the pivotal device in FIG. 1 mounted in the electrical device.

### DETAILED DESCRIPTION OF THE PREFERRED EMBODIMENT

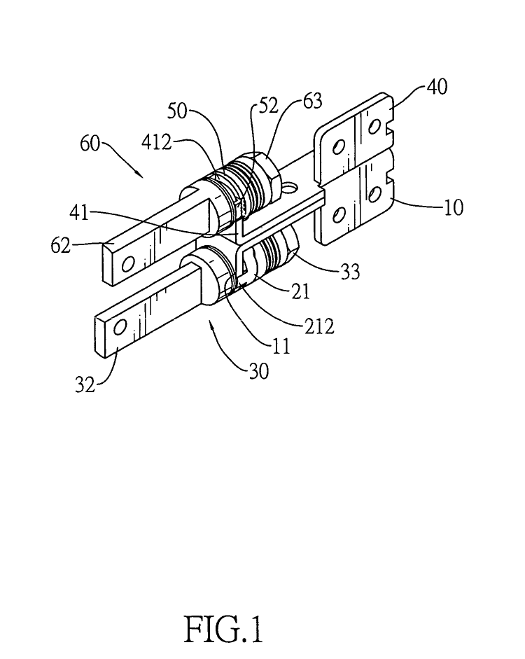

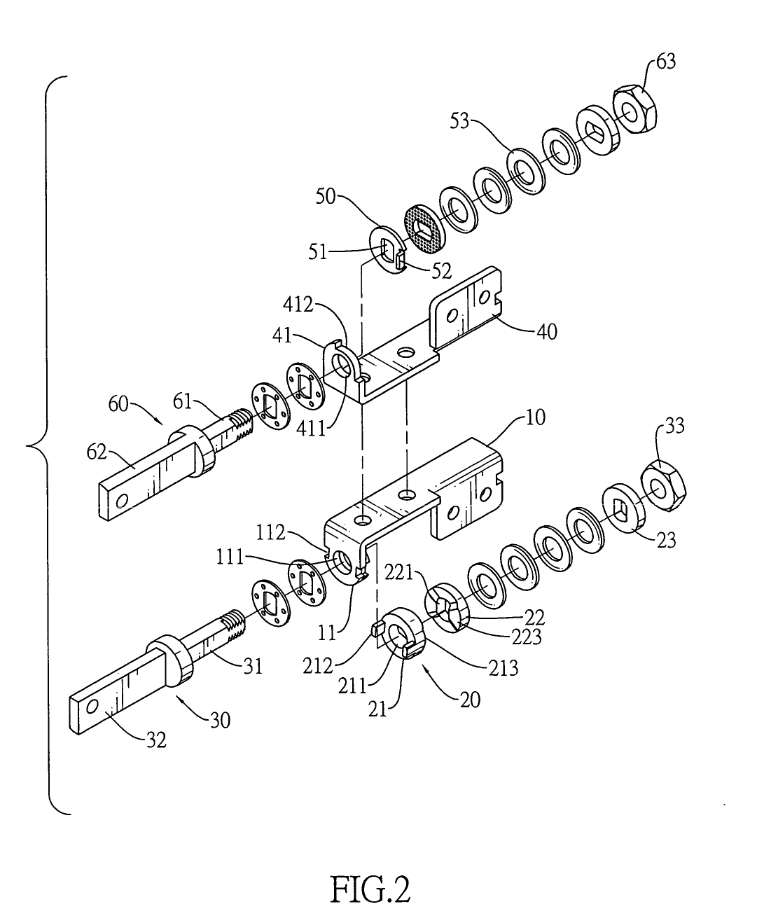

With reference to FIGS. 1 and 2, a pivotal device in accordance with the present invention has a first support (10), a first positioning member (20), a first axle (30), a second support (40), a second positioning member (50) and a second axle (60).

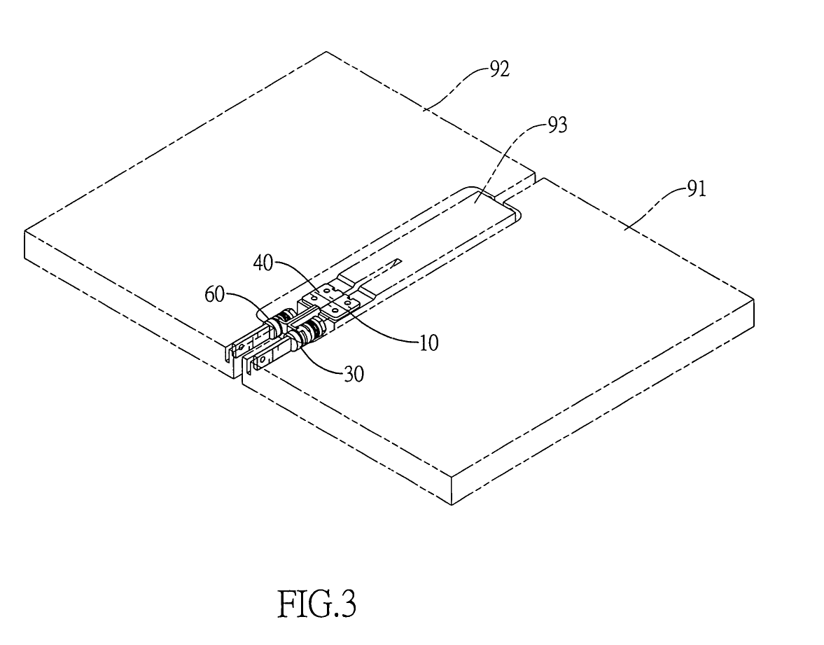

With further reference to FIG. 3, the pivotal device is mounted between a cover (92) and a base (91) of an electrical device that has a plate (93) mounted between the cover (92) and the base (91) and connected to the pivotal device.

The first support (10) is attached securely to the plane (93) and has a first seat (11) extending out of the first support (10). The first seat (11) has an axle hole (111) defined in the first seat (11) and two grooves (112) respectively defined in two sides of the first seat (11).

The first axle (30) is pivotally mounted on the first support (10) and has a first post (31) and a first holder (32). The first post (31) is inserted rotatably into the first axle hole (111) and the first holder (32) is extended out of an end of the first post (31) and is attached to the base (91).

The first positioning member (20) is mounted on the first axle (30) and has a stationary ring (21) and a movable ring (22). The stationary ring (21) is attached to the first seat (11) and is mounted rotatably around the first post (31). Two tabs (212) are formed on the stationary ring (21) and engage with the grooves (112). Multiple notches (213) are respectively defined in the stationary ring (21). The first post (31) is attached to and is inserted into the movable ring (22). The movable ring (22) has multiple lugs (223) formed on the movable ring (22) and corresponding to and selectively engaging the notches (213) of the stationary ring (21) to position the first axle (30) relative to the first support (10).

The second support (40) is attached securely to the first support (10) and the plane (93). The second support (40) has a second seat (41) extending out of the second support (40). The second seat (41) has an opening (411) defined through the second seat (41) and an arcuate channel (412) defined in an edge of the second seat (41).

The second axle (60) is pivotally provided on the second support (40) and parallel to the first axle (30) and has a second post (61) formed on the second axle (60) and a second holder (62) formed on the second axle (60). The second holder (61) is mounted rotatably in the opening (411) and the second holder (62) is attached securely to the cover (92).

The second positioning member (50) is mounted between the second support (40) and the second axle (60) and is mounted securely on the second post (61). The second positioning member (50) has a fin (51) extending out of the second positioning member (50) and provided slidably in the channel (412). Therefore, the second positioning member (50) can rotate along the channel (412).

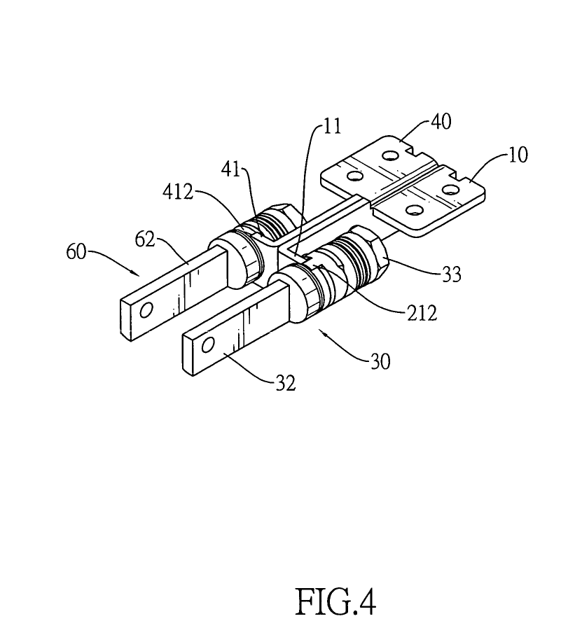

With reference to FIGS. 3 and 4, the first and the second axles (30, 60) can respectively rotate relative to the first and the second support (10, 40) and therefore, the cover (92), the base (91) and the pivotal device can completely unfold.

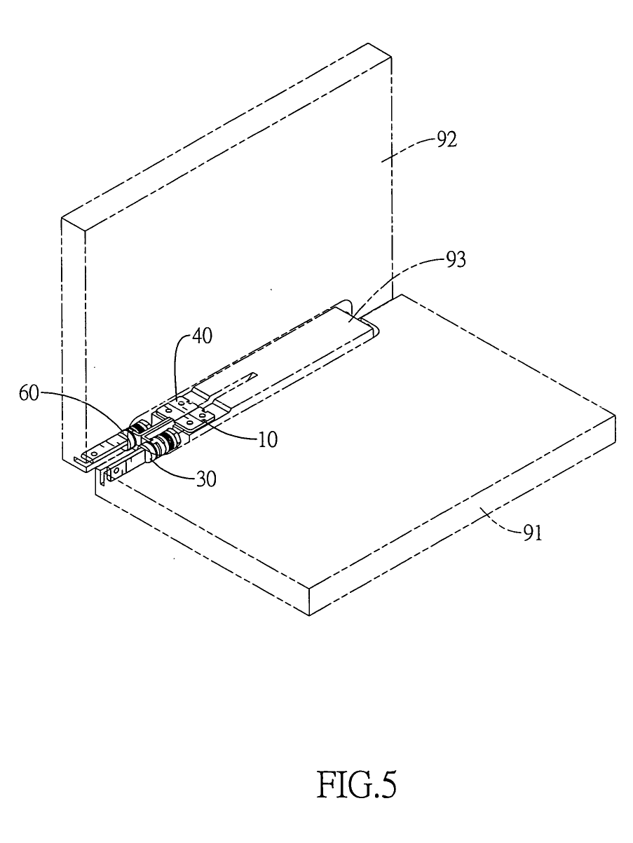

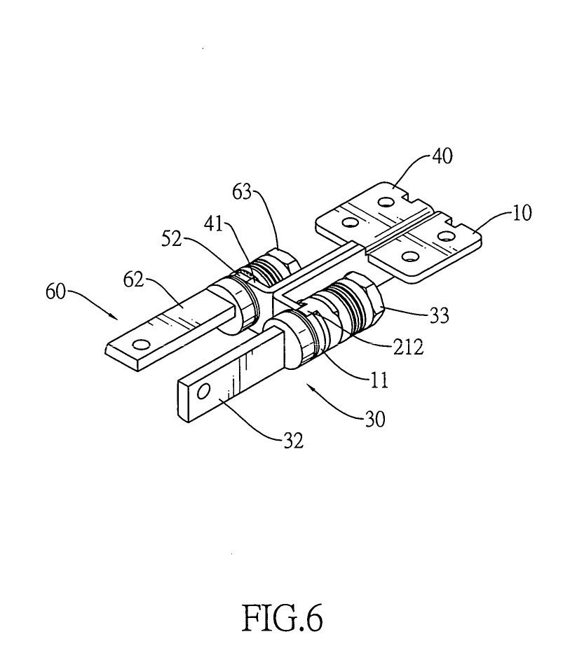

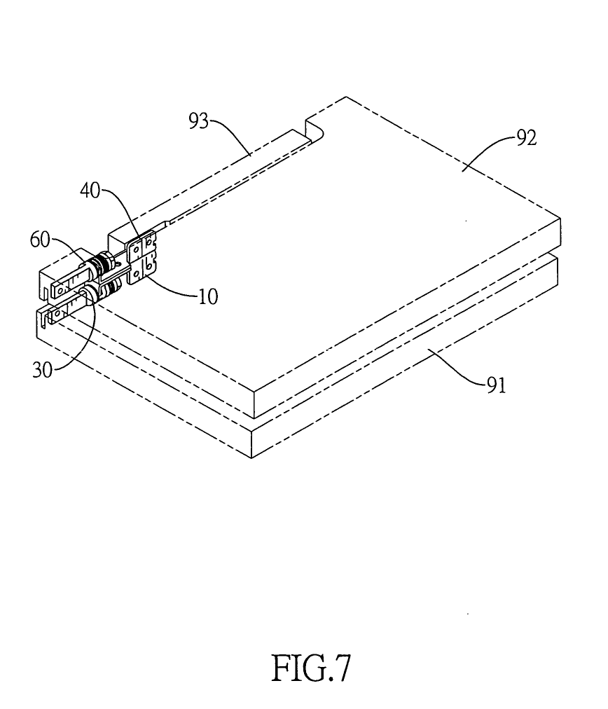

With reference to FIGS. 5 and 6, the cover (92) rotates the second axle (60) relative to the second support (40). Therefore, the cover (92) is perpendicular to the base (91) to be used easily. With further reference to FIG. 7, the cover (92) rotates the second axle (60) relative to the second support (40). The cover (92) is closed relative to the base (91) to be stored or carried easily.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A pivotal device comprising:
a first support having a first seat extending out of the fist support and having an axle hole defined in the first seat;
a first axle pivotally mounted on the first support and having
a first post inserted rotatably into the axle hole of the first seat and formed on a first end of the first axle; and
a first holder formed on a second end of the first axle;
a second support attached securely to the first support and having
a second seat extending out of the second support; and
an opening defined through the second seat; and
a second axle pivotally mounted on the second support and parallel to the first axle and having
a second post formed on the second axle and inserted rotatably into the opening of the second seat; and
a second holder extending out an end of the second post.

2. The pivotal device as claimed in claim 1, wherein a first positioning member is mounted on the first support and the first axle and has
an stationary ring attached securely to the first seat, mounted rotatably around the first post and having multiple notches defined in the stationary ring; and
a movable ring mounted securely on the first post and having multiple lugs formed on the movable ring and selectively engaging the notches in the stationary ring.

3. The pivotal device as claimed in claim 2, wherein two grooves are respectively defined in two sides of the first seat and two tabs are formed on the stationary ring and engaging with the grooves in the first seat.

4. The pivotal device as claimed in claim 3, wherein
an arcuate channel is defined in an edge of the second seat; and
a second positioning member is mounted between the second support and the second axle, is mounted securely on the second post and having a fin extending out of the second positioning member and provided slidably in the channel of the second seat.
